(19) United States
(12) Patent Application Publication
(10) Pub. No.: US 2025/0203723 A1
(43) Pub. Date: Jun. 19, 2025

(54) INDICATION SYSTEM FOR A COOKTOP

(71) Applicant: WHIRLPOOL CORPORATION, BENTON HARBOR, MI (US)

(72) Inventors: Marco Cammarata, Besozzo (IT); Andrea Gallivanoni, Casorate Sempione (IT); Annalisa Pacioni, Bresso (IT); Priscilla Rosaria Conforti, Varese (IT)

(73) Assignee: WHIRLPOOL CORPORATION, BENTON HARBOR, MI (US)

(21) Appl. No.: 18/545,246

(22) Filed: Dec. 19, 2023

(51) Int. Cl. H05B 6/12; H05B 6/06

(52) U.S. Cl. CPC H05B 6/1218; H05B 6/065; H05B 6/1272; H05B 2213/05

(57) ABSTRACT

A cooktop includes heater coils for heating cookware on at least one of a first portion and a second portion of a cooking area of the cooktop. A detection circuit is configured to detect a position of the cookware. A display includes a set of rows of lights. The set of rows of lights includes a first row of lights representative of a first range of heat levels for the first portion and a second row of lights representative of a second range of heat levels for the second portion. A controller is in communication with the detection circuit and the display. The controller is configured to adjust power to the heater coils in response to detection of the position of the cookware and selectively energize one of the first row of lights and the second row of lights in response to detection of the position of the cookware.

### BACKGROUND OF THE DISCLOSURE

The present disclosure generally relates to an indication system for a cooktop and, more particularly, to a display system that indicates a power level for and a position of cookware on an induction cooktop.

### SUMMARY OF THE DISCLOSURE

According to one aspect of the present disclosure, a cooktop includes a plurality of heater coils for heating cookware on at least one of a first portion and a second portion of a cooking area of the cooktop. A detection circuit is configured to detect a position of the cookware. A display includes a set of rows of lights. The set of rows of lights includes a first row of lights representative of a first range of heat levels for the first portion and a second row of lights representative of a second range of heat levels for the second portion. A controller is in communication with the detection circuit and the display. The controller is configured to adjust power to the plurality of heater coils in response to detection of the position of the cookware and selectively energize one of the first row of lights and the second row of lights in response to detection of the position of the cookware.

According to another aspect of the present disclosure, a system for indicating a target heat level of and a position of cookware on an induction cooktop includes a first row of lights representative of a first range of heat levels for a first portion of a cooking area of the induction cooktop. The system includes a second row of lights representative of a second range of heat levels for a second portion of the cooking area of the induction cooktop adjacent to the first portion. The system includes a controller in communication with the first and second rows of lights. The controller is configured to adjust power to heater coils of the cooking area based on the position of the cookware and selectively energize one of the first row of lights and the second row of lights in response to detection of the position of the cookware. Each of the first row of lights and the second row of lights is a one-dimensional array of lights, and the controller activates at least a portion of one of the first row of lights and the second row of lights to indicate the position of the cookware and the target heat level.

According to yet another aspect of the present disclosure, a cooktop includes a plurality of heater coils for heating cookware on at least one of a first portion and a second portion of a cooking area of said cooktop. A detection circuit is configured to detect a position of the cookware. A display includes a set of rows of lights. The set of rows of lights includes a first row of lights representative of a first range of heat levels for the first portion and a second row of lights representative of a second range of heat levels for the second portion. The first range of heat levels has a first minimum heating capacity and a first maximum heating capacity. The second range of heat levels has a second minimum heating capacity and a second maximum heating capacity. The second minimum heating capacity is equal to or greater than the first maximum heating capacity. the cooktop includes a controller in communication with the detection circuit and the display. The controller is configured to adjust power to the plurality of heater coils in response to detection of the position of the cookware and selectively energize one of the first row of lights and the second row of lights in response to detection of the position of the cookware.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top plan view of an induction cooktop including a display having an operable partial-slider arrangement and illustrating a control system for the induction cooktop;

FIG. 2A is a top plan view of a portion of a partial-slider display for an induction cooktop;

FIG. 2B is a top plan view of a portion of a full-slider display for an induction cooktop;

FIG. 3A is a top plan view of a portion of the partial-slider display of FIG. 2A demonstrating a target power level of 5 in a first operating mode;

FIG. 3B is a top plan view of a portion of the partial-slider display of FIG. 2A demonstrating a target power level of 9 in the first operating mode;

FIG. 3C is a top plan view of a portion of the partial-slider display of FIG. 2A demonstrating a target power level of 10 in the first operating mode;

FIG. 3D is a top plan view of a portion of the partial-slider display of FIG. 2A demonstrating a target power level of 16 in the first operating mode;

FIG. 4A is a top plan view of a portion of the partial-slider display of FIG. 2A demonstrating a target power level of 5 in a second operating mode;

FIG. 4B is a top plan view of a portion of the partial-slider display of FIG. 2A demonstrating a target power level of 9 in a second operating mode;

FIG. 4C is a top plan view of a portion of the partial-slider display of FIG. 2A demonstrating a target power level of 10 in a second operating mode;

FIG. 4D is a top plan view of a portion of the partial-slider display of FIG. 2A demonstrating a target power level of 16 in a second operating mode;

FIG. 5A is a top plan view of a portion of the full-slider display of FIG. 2B demonstrating a target power level of 5 in a first operating mode;

FIG. 5B is a top plan view of a portion of the full-slider display of FIG. 2B demonstrating a target power level of 9 in a first operating mode;

FIG. 5C is a top plan view of a portion of the full-slider display of FIG. 2B demonstrating a target power level of 10 in a first operating mode;

FIG. 5D is a top plan view of a portion of the full-slider display of FIG. 2B demonstrating a target power level of 16 in a first operating mode;

FIG. 6A is a top plan view of a portion of the full-slider display of FIG. 2B demonstrating a target power level of 5 in a second operating mode;

FIG. 6B is a top plan view of a portion of the full-slider display of FIG. 2B demonstrating a target power level of 9 in the second operating mode;

FIG. 6C is a top plan view of a portion of the full-slider display of FIG. 2B demonstrating a target power level of 10 in the second operating mode; and

FIG. 6D is a top plan view of a portion of the full-slider display of FIG. 2B demonstrating a target power level of 16 in the second operating mode.

The components in the figures are not necessarily to scale, emphasis instead being placed upon illustrating the principles described herein.

### DETAILED DESCRIPTION

The present illustrated embodiments reside primarily in combinations of method steps and apparatus components related to an indication system for a cooktop. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

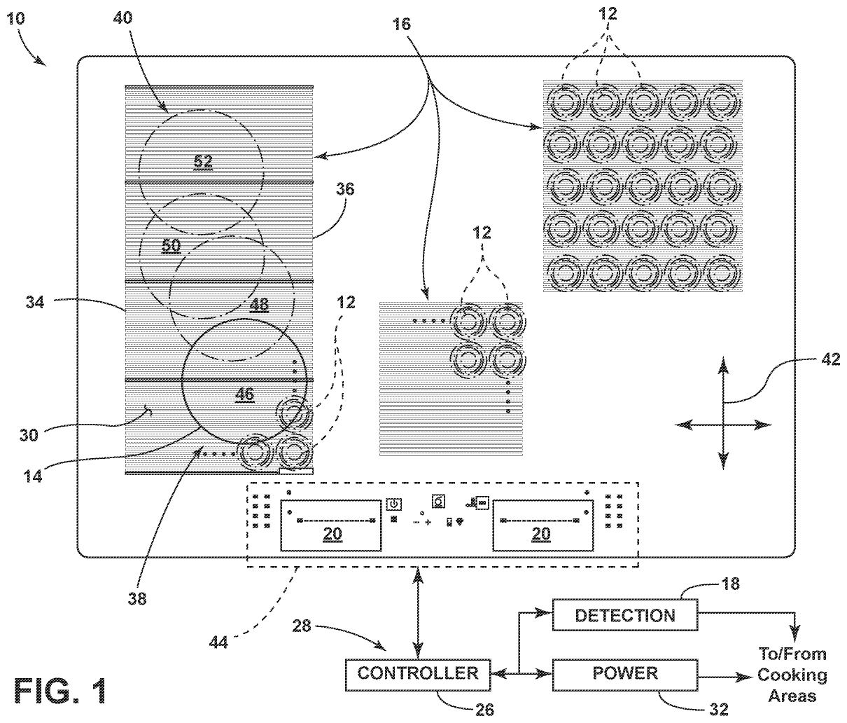

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

In general, the present disclosure provides a method and arrangement for enhancing the presentation of cooking information to a user of a cooking appliance. For example, the cooking information can be presented indicating the position and target heat level for pots, pans, or other cooking utensils atop an induction cooking appliance. The interface arrangement on the cooking appliances may further, or alternatively, provide enhanced visual feedback to the user using only limited space on the cooking appliance. For example, when such an induction cooking appliance is a flexible cooking arrangement that provides different heating levels for the pot/pan based on the position of the pot/pan, the present arrangement can indicate both the position and the power level for the pot/pan using a limited number of light-emitting diodes (LEDs), a seven-segment display, or other illumination arrangements that are cost-efficient. In this way, the present control assembly and method can provide an enhanced experience to the user.

In a preferred example, the enhanced presentation of cooking information is provided for a cooking arrangement that allows the user to freely move cooking vessels along a surface of the cooking appliance, such as in a forward-rearward direction, a side-to-side direction, or a combination thereof, to move the cooking vessels into different heating zones. The user can receive visual feedback from the present illumination arrangement indicating the position and the target power level of the cooking vessels without the need for higher-cost components, such as a graphical user interface (GUI).

Referring to FIGS. 1-6D, reference numeral 10 generally designates a cooktop. The cooktop 10 includes a plurality of heater coils 12 for heating cookware 14 on at least one of a first portions and a second portion of a cooking area 16 of the cooktop 10. A detection circuit 18 is configured to detect a position of the cookware 14. The cooktop 10 further includes a display 20 that includes a set of rows of lights 22, 24. The set of rows of lights 22, 24 includes a first row of lights 22 representative of a first range of heat levels for the first portion. The set of rows of lights 22, 24 further includes a second row of lights 24 representative of a second range of heat levels for the second portion. A controller 26 is in communication with the detection circuit 18 and the display 20. The controller 26 is configured to adjust power to the plurality of heater coils 12 in response to detection of the position of the cookware 14. The controller 26 is further configured to selectively energize one of the first row of lights 22 and the second row of lights 24 in response to detection of the position of the cookware 14. In a preferred example, the cooktop 10 is an induction cooktop.

With continued reference to FIGS. 1-6D, a control system 28 is provided for indicating a target power level of and a position of the cookware 14 on an induction cooktop. The first row of lights 22 is representative of the first range of heat levels for the first portion of a cooking area 16 of the induction cooktop. The second row of lights 24 is representative of the second range of heat levels for the second portion of the cooking area 16 of the induction cooktop adjacent to the first portion. The controller 26 is in communication with the first and second rows of lights 22, 24 and is configured to adjust power to the plurality of heater coils 12 of the cooking area 16 based on the position of the cookware 14. The controller 26 is configured to selectively energize one of the first row of lights 22 and the second row of lights 24 in response to detection of the position of the cookware 14. Each of the first row of lights 22 and the second row of lights 24 may be a one-dimensional array of lights. The controller 26 is configured to activate at least a portion of one of the first row of lights 22 and the second row of lights 24 to indicate the position of the cookware 14 and the target power level.

In general, the cooktop 10 may be operable between a manual mode in which the user can manually control the heating level(s) of the cooktop 10 and an automatic mode in which the cooktop 10 automatically controls the heating level(s) in response to the position of the cookware 14. A user can selectively adjust between the operating modes of the control system 28 (e.g., the controller 26, the display 20, and the plurality of heater coils 12) to enable the position-based control.

Referring to FIG. 1, the display 20 of the present disclosure is configured to indicate both the position and the target power level for the cookware 14 in one or more cooking areas 16 of the cooktop 10. For example, the cooking area 16 may include a cooking surface 30 below which is disposed a plurality of heater coils 12. The plurality of heater coils 12 are induction coils that wirelessly heat the cookware 14 at different power levels via control of current and/or voltage to the plurality of heater coils 12. Accordingly, the plurality of heater coils 12 may be controlled by power circuitry 32 incorporating transistors, capacitors, inverters, and/or circuitry that facilitates current through the plurality of heater coils 12. It is contemplated that, while a two-dimensional matrix of heater coils 12 is illustrated in FIG. 1, in some examples, the heater coils 12 forms a one-dimensional array of heating zones. Further, while the coils 12 illustrated are substantially similar in shape (e.g., circular), it is contemplated that the coils 12 may have any shape (e.g., substantially square, semi-rectangular, substantially rectangular, elliptical, substantially triangular, hexagonal, or any other polygonal-or arcuate-shape) and be arranged in any pattern or array. Further, the proximity to one another may be constructed as illustrated or alternatively (e.g., greater or lesser spacing).

The cooktop 10 includes a controller 26 that controls the power control circuitry to produce the target power level in a target region of the cooking area 16. For example, the controller 26 may selectively energize one or more inverters corresponding to one or more of the plurality of heater coils 12 that are disposed below a position of the cookware 14 being heated at a target frequency, while limiting activation of other inverters corresponding to other of the plurality of heater coils 12 under other regions of the cooking area 16. In this way, the controller 26 can control the plurality of heater coils 12 to heat a local part of the cooking area 16.

With continued reference to FIG. 1, to determine where the cookware 14 is located in the cooking area 16, the controller 26 is in communication with a detection circuit 18 that detects the position of the cookware 14. In some examples, the detection circuit 18 includes one or more electrical components in series or parallel with one or more of the plurality of heater coils 12 that are sensitive to feedback power. For example, the detection circuit 18 can include inductors or capacitors that close or open circuits monitored by the controller 26 in response to the presence of the cookware 14 above corresponding heater coils 12. Just as currents may be induced in the cookware 14 by the heater coils 12, currents may be induced in the detection circuit 18 in this example. In some examples, the detection circuit 18 is a light sensor, such as an infrared sensor, an imaging device that captures images or video of the cooktop 10, or is another external or internal sensor that detects the position of the cookware 14. A separate signal processor or a separate video processor may be used in combination with the controller 26 to detect/determine the presence of the cookware 14 in the cooking area 16 in some examples. In general, the detection circuit 18 communicates signals to the controller 26 in response to the position of the cookware 14 (e.g., pots, pans, or other cooking utensils).

With continued reference to FIG. 1, the cooktop 10 includes a ceramic layer (e.g., glass) which forms the cooking surface 30 for the cookware 14 to freely move upon. As the user moves the cookware 14 along the cooking surface 30 in the cooking area 16, the controller 26 tracks the position of the cookware 14 based on the signals from the detection circuit 18 and, using a predefined or dynamic heat distribution pattern, controls the plurality of heater coils 12 in response to the position of the cookware 14. The heat distribution pattern can refer to the relationship between the target heat levels and the location in the cooking area 16. Such heat distributions may be programmed by the user or the manufacturer. The heat distribution pattern may be one of a plurality of patterns selectable by the user. The patterns may follow a spatial-logical design, such as a linear or semi-linear gradient from one part of the cooking area 16 to another part of the cooking area 16.

For example, a left side 34 of a given cooking area 16 may correspond to a highest heating level, a right side 36 of the cooking area 16 may correspond to a lowest heating level, and the power levels may decrease linearly or semi-linearly from left to right. In another example, a center of the one part of the cooktop 10 has a highest heating level relative to peripheral parts of that part of the cooktop 10, and the heating levels form a heating gradient between the central portion and the peripheral portions 72. It is contemplated that these heat distribution patterns are exemplary and non-limiting—other heat distribution patterns may be programmed or limited by the hardware of the cooktop 10 (e.g., higher-powered coils located in one region vs. another region of the cooking area 16). In the examples demonstrated in FIGS. 1-6D, the heat distribution pattern is a low-to-mid-to-high pattern from a front area 38 to a rear area 40 of the cooktop 10 in a cooktop-frontward-rearward direction 42. Thus, as the cookware 14 moves from the front toward the rear of the cooktop 10, the target power level increases generally linearly in the present examples.

Still referring to FIG. 1, the cooktop 10 includes an interface area 44 that includes the display 20. The interface area 44 may include switches, buttons (e.g., touch-buttons), screens, or any other interface that the user can interact with to control various features of the cooktop 10. While disposed near a front of the cooktop 10 in the present example, the interface area 44 may be disposed of at any part of the cooktop 10.

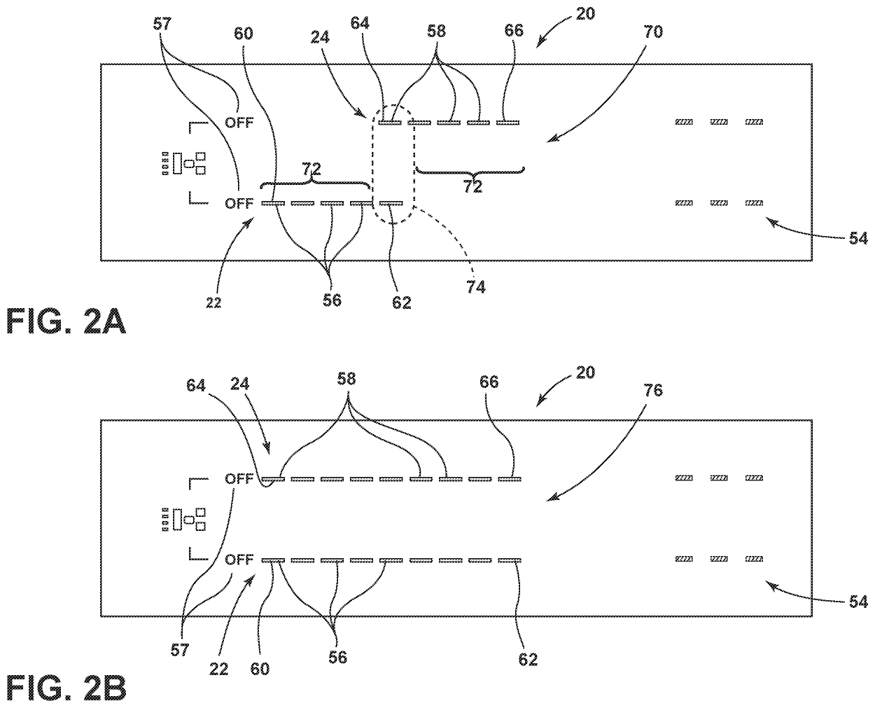

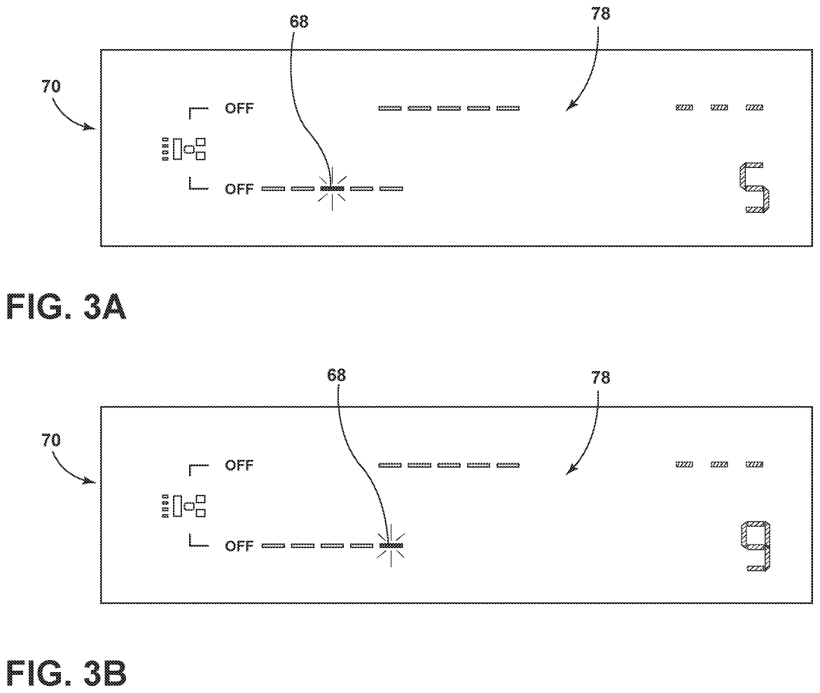

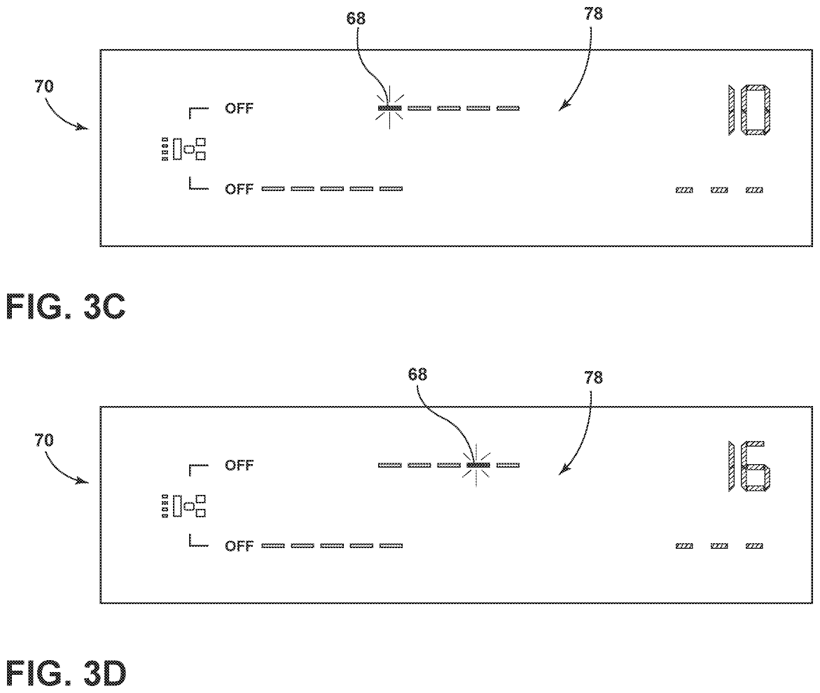

When the cookware 14 is moved along the cooking area 16 (e.g., between the first portion and the second portion), the display controls lighting in the interface area 44 to indicate the position of the cookware 14 and the target power level corresponding to the position. Various examples of how this cooking information will be described in reference to FIGS. 2A-6D. For example, FIG. 1 demonstrates the cookware 14 in a first position 46, with other positions for the cookware 14 (a second position 48, a third position 50, and a fourth position 52) presented in dashed lines. For example, each set of FIGS. 3A-3D, 4A-4D, 5A-5D, and 6A-6D, demonstrates a movement of the cookware 14 from the first-fourth positions 46, 48, 50, 52 in the cooktop-frontward-rearward direction 42 between a first portion of the cooktop 10 (e.g., the front area 38) and a second portion of the cooktop 10 (e.g., the rear area 40).

Referring now to FIGS. 2A and 2B, the display 20 includes the set of rows previously described and a character display 54. The character display 54 may include a seven-segment display that presents a numeric representation of the target power level. The sets of rows include a first row of lights 22 that corresponds to the first portion (e.g., the front portion) and a second row of lights 24 that corresponds to the second portion (e.g., the rear portion). As previously described, it is contemplated that the number of rows/the number of portions may be different than two in other examples (e.g., a three-zone arrangement having three rows). In any of these examples, the indication features of the present disclosure are controlled to be representative of position and target power in the automatic mode. Although not illustrated in detail, touch sensors may be provided in an array near/around the set of rows of lights 22, 24 to allow the user to set the power level for a given part of the cooking area 16 in the manual mode. For example, the set of rows may correspond to “sliders,” such as a touch slider that extends laterally.

In the present example, the first range of heat levels corresponding to the first portion has a first minimum heating capacity and a first maximum heating capacity. The second range of heat levels corresponding to the second portion has a second minimum heating capacity and a second maximum heating capacity. For example, in a cooking area 16 that supports power levels between 0 and 18, the first portion may support power levels between 1 and 9, and the second portion may support power levels between 10 and 18. In this way, the second minimum heating capacity can be equal to or greater than the first maximum heating capacity. Of course, each of the first portion and the second portion may support a power level of 0 or an “off state” as indicated by the OFF indicator 57 proximate to each of the first and second rows of lights 22, 24. In one example, the first range of heat levels is the same, or substantially the same, as the second range of heat levels. For example, in a cooking area 16 that supports power levels between 0 and 18, the first portion may support power levels between 0 and 18, and the second portion may support power levels between 0 and 18. Conversely, the first and second ranges of heat levels may be different from one another as previously described.

Still referring to FIGS. 2A and 2B, the first row of lights 22 includes a plurality of first lights 56 and the second row of lights 24 includes a plurality of second lights 58 each operable in a low illumination mode (indicated by cross-hatching) and a high illumination mode (indicated by a “starburst”). More specifically, each segment, or light, is individually addressable by the controller 26 in one of three states: off, on and dim, and on and bright. The illumination level/mode of the first and second lights 56, 58 is determined based on the position of the cookware 14 and, in-turn, the target heat level for the cookware 14. In general, the set of rows of lights 22, 24 indicates the position of the cookware 14 and a target heat level for the cookware 14. For example, controller 26 can activate at least a portion of one of the first row of lights 22 and the second row of lights 24 to indicate the position of the cookware 14 and a target heat level for the cookware 14. It is contemplated that the first and second lights 56, 58 may be individual arrays of light sources (e.g., a plurality of LEDs) or a single LED corresponding to each light. Thus, while the lights are referred to as single lights, such description is merely exemplary and non-limiting. Rather, differentiation between individual lights of the set of rows of lights 22, 24 may refer to individual segments, or visually distinguishable units, of lights.

The first row of lights 22 extends between a first end light 60 corresponding to the first minimum heating capacity and a second end light 62 corresponding to the first maximum heating capacity. The second row of lights 24 extends between a third end light 64 corresponding to the second minimum heating capacity and a fourth end light 66 corresponding to the second maximum heating capacity. The first row of lights 22 is disposed in parallel to and is noncolinear with the second row of lights 24. It is contemplated that each of the first row of lights 22 and the second row of lights 24 may be a one-dimensional array of lights. For example, each of the first and second rows of lights 22, 24 may be a string of indication segments arranged in a line.

The first row of lights 22 is disposed frontward of the second row of lights 24 to provide a logical relationship to the physical arrangement of the first portion relative to the second portion. In this way, as the cookware 14 is moved in a low power-to-high power direction, the first and second lights 56, 58 can be controlled to represent the movement. For example, as will be described with respect to the foregoing figures, the controller 26 is configured to illuminate a target light 68 of the set of rows of lights 22, 24 in the high illumination mode. The target light 68 corresponds to the position of the cookware 14 on either of the first portion or the second portion. The controller 26 further determines the target heat level for the cookware 14 based on the position of the cookware 14.

Referring more specifically to FIG. 2A, the set of rows of lights 22, 24 may form a partial-slider arrangement 70, or “short slider” arrangement. In this arrangement, the second end light 62 and the third end light 64 are aligned in the cooktop-frontward-rearward direction 42. In some examples, the second end light 62 and the third end light 64 do not overlap laterally, but rather are offset such that the third end light 64 is disposed to the right of the second end light 62. In either example, the second row of lights 24 is laterally offset from the first row of lights 22, such that the first end light 60 corresponds to the lowest power level and the fourth end light 66 corresponds to the highest power level. Accordingly, the set of rows of lights 22, 24 have peripheral portions 72 and may have some or none of an overlapping portion 74.

Referring now to FIG. 2B, the set of rows of lights 22, 24 may form a full-slider arrangement 76. In this arrangement, the first end light 60 and third end light 64 are aligned in the cooktop-frontward-rearward direction 42 and the second end light 62 and fourth end light 66 are aligned in the cooktop-frontward-rearward direction 42. In this example, first and second rows of lights 22, 24 are laterally overlapped completely. It is contemplated that, in either arrangement (the partial- 70 or full-slider arrangement 76), the plurality of first and second lights 56, 58 are operable between off, dim, and bright.

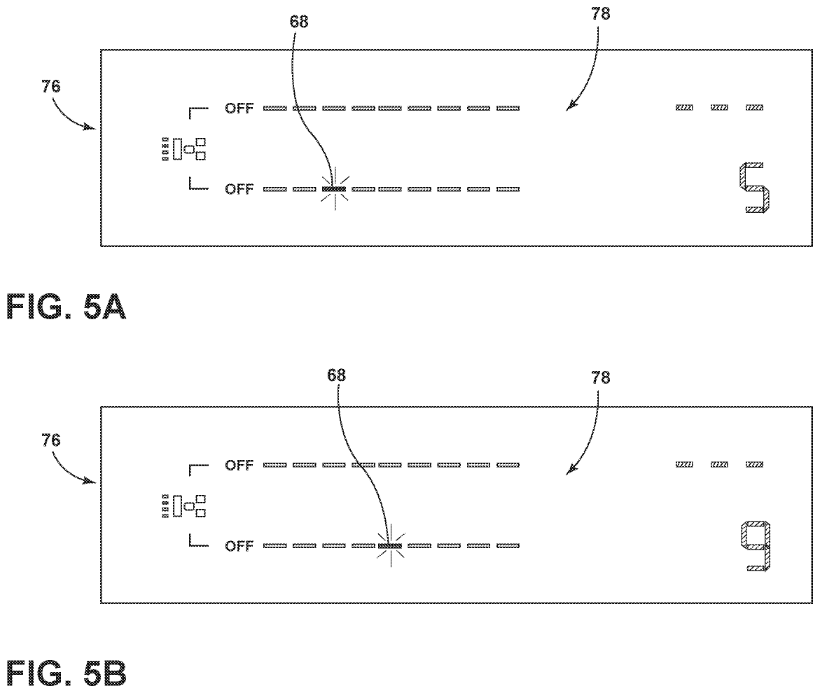

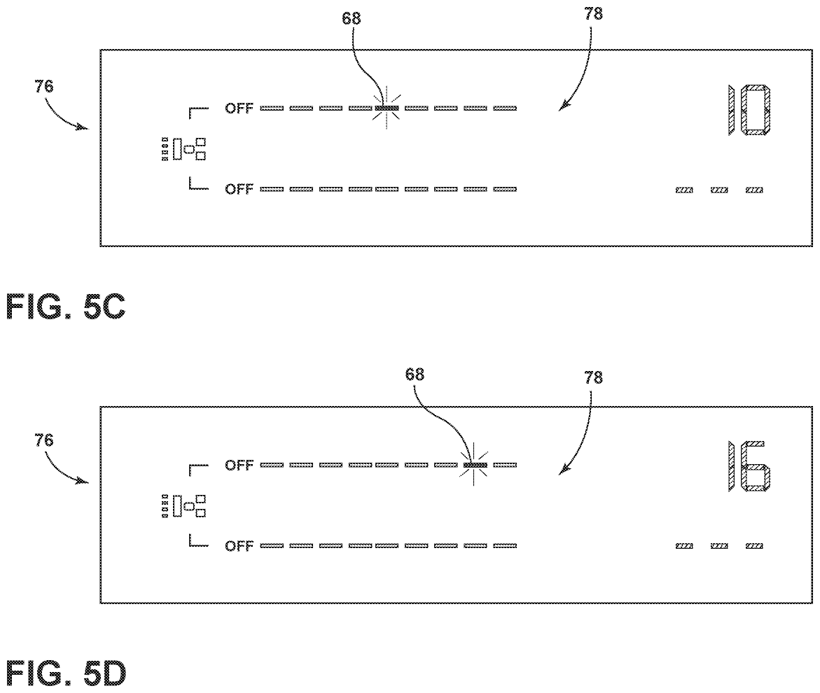

In either the partial-slider arrangement 70 or the full-slider arrangement 76, the set of rows may be operable in a single-light mode 78 (FIGS. 3A-3D and 5A-5D) or a multi-light mode 80 (FIGS. 3A-4D and 6A-6D). In the single-light mode 78, the controller 26 is configured to determine a target row among the first row of lights 22 and the second row of lights 24 that includes the target light 68. The controller 26 is further configured to operate only the target light 68 in the high illumination mode of all lights in the target row. The controller 26 may therefore be configured to activate only the target light 68 at the high illumination level of all lights in the set of rows of lights 22, 24. Accordingly, the target light 68 in either of the first or second rows of lights 22, 24 that corresponds to the target power level (and, in-turn, the position of the cookware 14) is illuminated in the bright mode and the remainder of the lights in the set of rows of lights 22, 24 are illuminated in the low brightness mode or are off. In this way, as the cookware 14 is moved, a single indicator moves in a scaled manner within the set of rows of lights 22, 24. The character display 54 is also configured to update to the target power level as the cookware 14 is moved.

In the multi-light mode 80, the controller 26 is configured to determine a target row among the first and second rows of lights 22, 24 that includes the target light 68, and activate only lights in the target row that correspond to heating levels equal to and/or lower than the target heat level. In this way, as the cookware 14 is moved, an indicator stack (e.g., a bar of segments) moves in a scaled manner within the set of rows of lights 22, 24.

Referring now to FIGS. 3A-3D, the motion sequence from the first position 46 of the cookware 14 of FIG. 1 to the fourth position 52 is indicated by the display 20 having the partial-slider arrangement 70 and operating in the single-light mode 78. In the first position 46 (FIG. 3A), there is a power level of 5 and only a third segment (the target light 68) of the first row of lights 22 is illuminated in the high illumination mode. In the second position 48 (FIG. 3B), there is a power level of 9 and only a fifth segment (the target light 68) of the first row of lights 22 is illuminated in the high illumination mode. In the third position 50 (FIG. 3C), there is a power level of 10 and only a first segment (the target light 68) of the second row of lights 24 is illuminated in the high illumination mode. In the fourth position 52 (FIG. 3D), there is a power level of 16 and only a fourth segment (the target light 68) of the second row of lights 24 is illuminated in the high illumination mode.

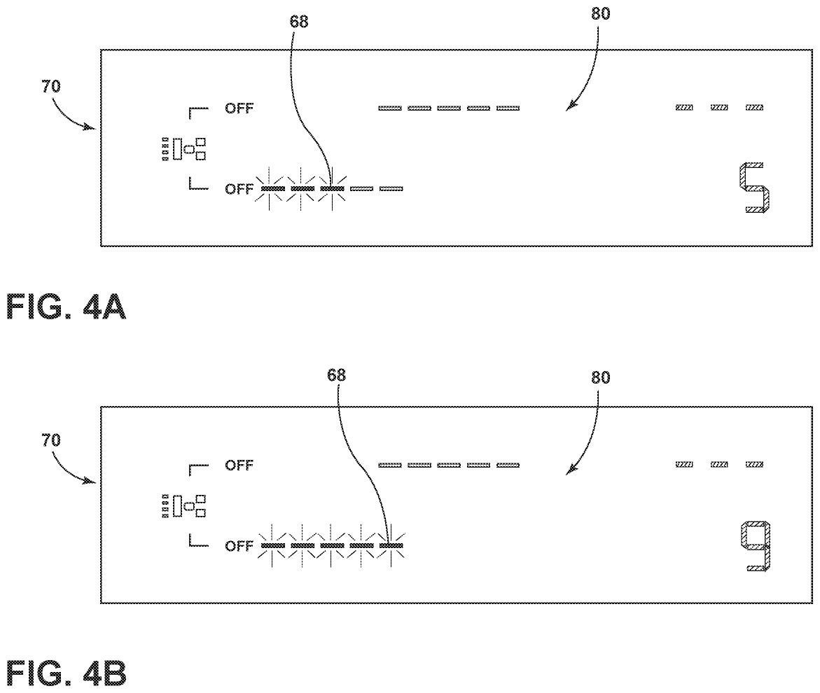

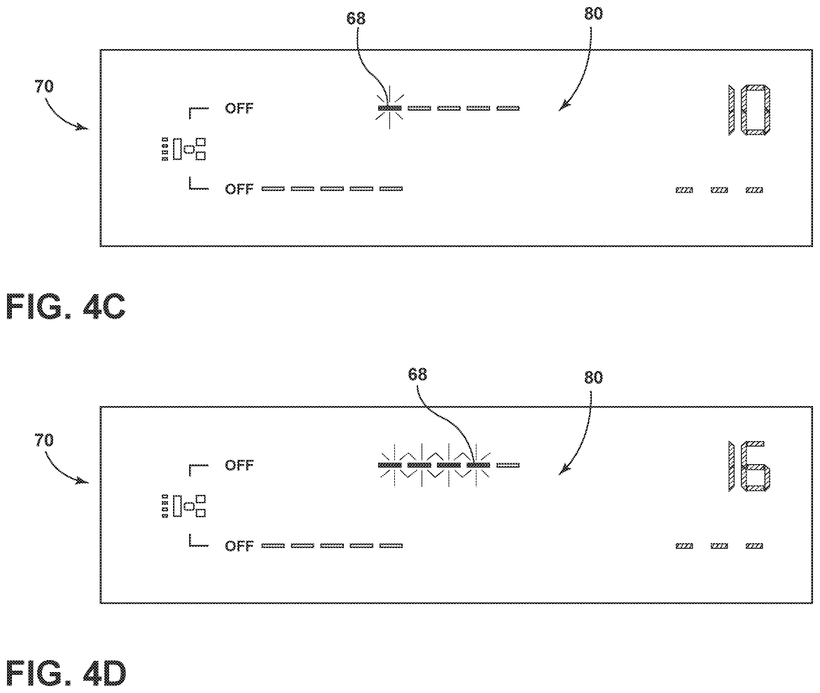

Referring now to FIGS. 4A-4D, the motion sequence from the first position 46 of the cookware 14 of FIG. 1 to the fourth position 52 is indicated by the display 20 having the partial- slider arrangement 70 and operating in the multi-light mode 80. In the first position 46 (FIG. 4A), there is a power level of 5, a third segment (the target light 68) of the first row of lights 22 is illuminated in the high illumination mode, and all lights having a lower power level than the target power level in the target row are also illuminated in the high illumination mode. In the second position 48 (FIG. 4B), there is a power level of 9, a fifth segment (the target light 68) of the first row of lights 22 is illuminated in the high illumination mode, and all lights having a lower power level than the target power level in the target row are also illuminated in the high illumination mode. In the third position 50 (FIG. 4C), there is a power level of 10, a first segment (the target light 68) of the second row of lights 24 is illuminated in the high illumination mode, and all lights having a lower power level than the target power level in the target row are also illuminated in the high illumination mode. In the fourth position 52 (FIG. 4D), there is a power level of 16, a fourth segment (the target light 68) of the second row of lights 24 is illuminated in the high illumination mode, and all lights having a lower power level than the target power level in the target row are also illuminated in the high illumination mode.

Referring now to FIGS. 5A-5D, the motion sequence from the first position 46 of the cookware 14 of FIG. 1 to the fourth position 52 is indicated by the display 20 having the full-slider arrangement 76 and operating in the single-light mode 78. In the first position 46 (FIG. 5A), there is a power level of 5 and only a third segment (the target light 68) of the first row of lights 22 is illuminated in the high illumination mode. In the second position 48 (FIG. 5B), there is a power level of 9 and only a fifth segment (the target light 68) of the first row of lights 22 is illuminated in the high illumination mode. In the third position 50 (FIG. 5C), there is a power level of 10 and only a fifth segment (the target light 68) of the second row of lights 24 is illuminated in the high illumination mode. In the fourth position 52 (FIG. 5D), there is a power level of 16 and only an eighth segment (the target light 68) of the second row of lights 24 is illuminated in the high illumination mode.

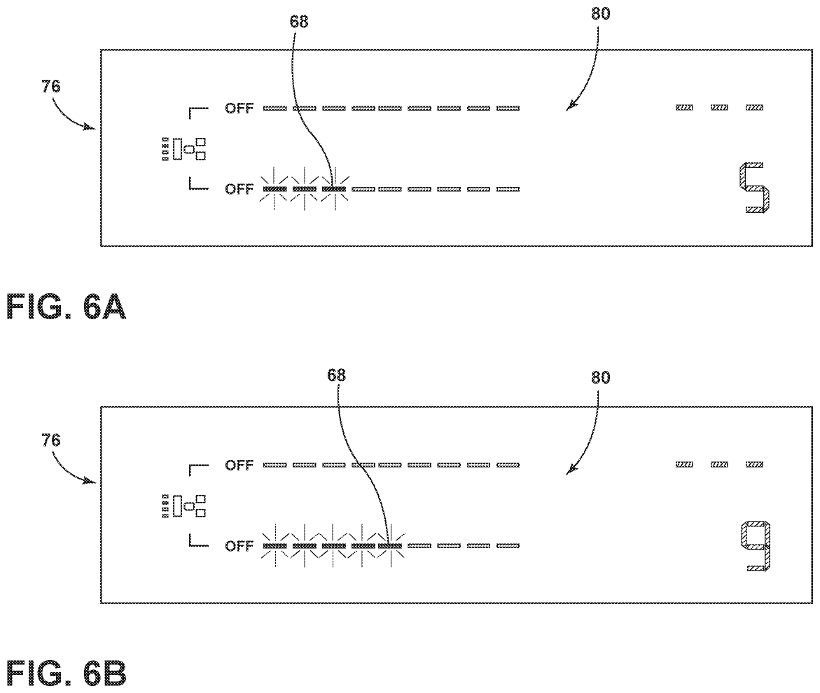

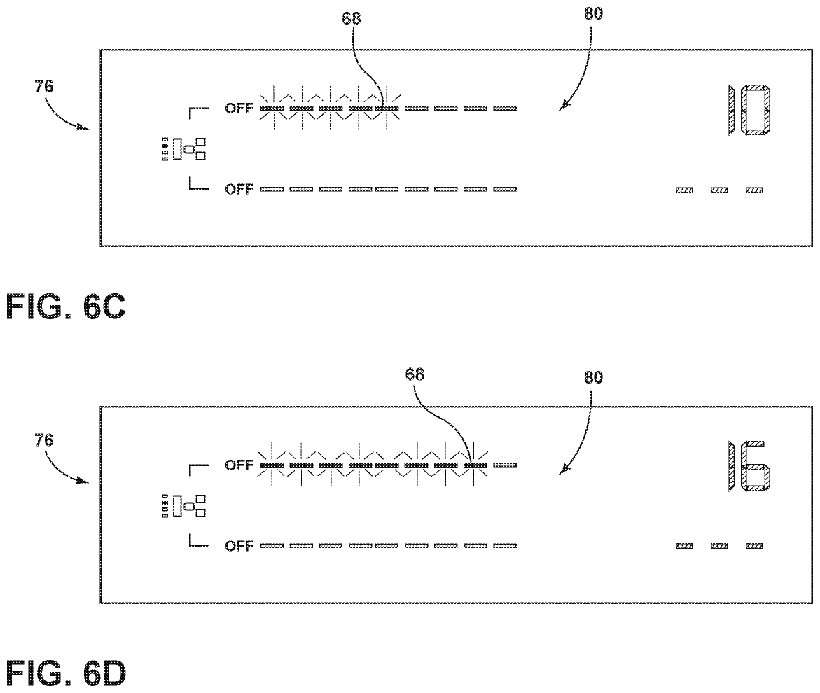

Referring now to FIGS. 6A-6D, the motion sequence from the first position 46 of the cookware 14 of FIG. 1 to the fourth position 52 is indicated by the display 20 having the full-slider arrangement 76 and operating in the multi-light mode 80. In the first position 46 (FIG. 6A), there is a power level of 5, a third segment (the target light 68) of the first row of lights 22 is illuminated in the high illumination mode, and all lights having a lower power level than the target power level in the target row are also illuminated in the high illumination mode. In the second position 48 (FIG. 6B), there is a power level of 9, a fifth segment (the target light 68) of the first row of lights 22 is illuminated in the high illumination mode, and all lights having a lower power level than the target power level in the target row are also illuminated in the high illumination mode. In the third position 50 (FIG. 6C), there is a power level of 10, a fifth segment (the target light 68) of the second row of lights 24 is illuminated in the high illumination mode, and all lights having a lower power level than the target power level in the target row are also illuminated in the high illumination mode. In the fourth position 52 (FIG. 6D), there is a power level of 16, an eighth segment (the target light 68) of the second row of lights 24 is illuminated in the high illumination mode, and all lights having a lower power level than the target power level in the target row are also illuminated in the high illumination mode.

The invention disclosed herein is further summarized in the following paragraphs and is further characterized by combinations of any and all of the various aspects described therein.

According to another aspect of the present disclosure, a cooktop includes a plurality of heater coils for heating cookware on at least one of a first portion and a second portion of a cooking area of the cooktop. A detection circuit is configured to detect a position of the cookware. A display includes a set of rows of lights. The set of rows of lights includes a first row of lights representative of a first range of heat levels for the first portion and a second row of lights representative of a second range of heat levels for the second portion. A controller is in communication with the detection circuit and the display. The controller is configured to adjust power to the plurality of heater coils in response to detection of the position of the cookware and selectively energize one of the first row of lights and the second row of lights in response to detection of the position of the cookware.

According to another aspect of the present disclosure, the first range of heat levels has a first minimum heating capacity and a first maximum heating capacity, the second range of heat levels has a second minimum heating capacity and a second maximum heating capacity, and wherein the second minimum heating capacity is equal to or greater than the first maximum heating capacity.

According to another aspect of the present disclosure, the first row of lights extends between a first end light corresponding to the first minimum heating capacity and a second end light corresponding to the first maximum heating capacity, and wherein the second row of lights extends between a third end light corresponding to the second minimum heating capacity and a fourth end light corresponding to the second maximum heating capacity.

According to another aspect of the present disclosure, the first row of lights is parallel to and noncolinear with the second row of lights.

According to another aspect of the present disclosure, the controller is configured to illuminate a target light of the set of rows of lights in a high illumination mode, the target light corresponding to the position of the cookware on either of the first portion or the second portion.

According to another aspect of the present disclosure, the controller determines a target heating level for the cookware based on the position of the cookware.

According to another aspect of the present disclosure, the controller is configured to activate only the target light at the high illumination level of all lights in the set of rows of lights.

According to another aspect of the present disclosure, the controller is configured to determine a target row among the first row of lights and the second row of lights that includes the target light and operates only the target light in the high illumination mode of all lights in the target row.

According to another aspect of the present disclosure, the controller is configured to determine a target row among the first and second rows of lights that includes the target light and activate only lights in the target row that correspond to heating levels equal to and lower than the target heating level.

According to another aspect of the present disclosure, each of the first row of lights and the second row of lights is a one-dimensional array of lights, and the controller activates at least a portion of one of the first row of lights and the second row of lights to indicate the position of the cookware and a target heating level for the cookware.

According to another aspect of the present disclosure, the first range of heat levels is different than the second range of heat levels.

According to another aspect of the present disclosure, a system for indicating a target power level of and a position of cookware on an induction cooktop includes a first row of lights representative of a first range of heat levels for a first portion of a cooking area of the induction cooktop. The system includes a second row of lights representative of a second range of heat levels for a second portion of the cooking area of the induction cooktop adjacent to the first portion. The system includes a controller in communication with the first and second rows of lights. The controller is configured to adjust power to heater coils of the cooking area based on the position of the cookware and selectively energize one of the first row of lights and the second row of lights in response to detection of the position of the cookware. Each of the first row of lights and the second row of lights is a one-dimensional array of lights, and the controller activates at least a portion of one of the first row of lights and the second row of lights to indicate the position of the cookware and the target power level.

According to another aspect of the present disclosure, the first range of heat levels has a first minimum heating capacity and a first maximum heating capacity, the second range of heat levels has a second minimum heating capacity and a second maximum heating capacity, and wherein the second minimum heating capacity is equal to or greater than the first maximum heating capacity.

According to another aspect of the present disclosure, the first row of lights extends between a first end light corresponding to the first minimum heating capacity and a second end light corresponding to the first maximum heating capacity, and wherein the second row of lights extends between a third end light corresponding to the second minimum heating capacity and a fourth end light corresponding to the second maximum heating capacity.

According to another aspect of the present disclosure, the first row of lights is parallel to and noncolinear with the second row of lights.

According to another aspect of the present disclosure, the controller is configured to illuminate a target light in one of the first row of lights and the second row of lights in a high illumination mode, the target light corresponding to the position of the cookware on either of the first portion or the second portion.

According to another aspect of the present disclosure, the controller is configured to activate only the target light at the high illumination level of all lights in the set of rows of lights.

According to another aspect of the present disclosure, the controller is configured to determine a target row among the first row of lights and the second row of lights that includes the target light and operate only the target light in the high illumination mode of all lights in the target row.

According to another aspect of the present disclosure, the controller is configured to determine a target row among the first and second rows of lights that includes the target light and activate only lights in the target row that correspond to heating levels equal to and lower than the target heating level.

According to another aspect of the present disclosure, a cooktop includes a plurality of heater coils for heating cookware on at least one of a first portion and a second portion of a cooking area of said cooktop. A detection circuit is configured to detect a position of the cookware. A display includes a set of rows of lights. The set of rows of lights includes a first row of lights representative of a first range of heat levels for the first portion and a second row of lights representative of a second range of heat levels for the second portion. The first range of heat levels has a first minimum heating capacity and a first maximum heating capacity. The second range of heat levels has a second minimum heating capacity and a second maximum heating capacity. The second minimum heating capacity is equal to or greater than the first maximum heating capacity. The cooktop includes a controller in communication with the detection circuit and the display. The controller is configured to adjust power to the plurality of heater coils in response to detection of the position of the cookware and selectively energize one of the first row of lights and the second row of lights in response to detection of the position of the cookware.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system 28 may be varied, the nature or number of adjustment positions provided between the elements may be varied. It should be noted that the elements and/or assemblies of the system 28 may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooktop, comprising:
a plurality of heater coils for heating cookware on at least one of a first portion and a second portion of a cooking area of said cooktop;
a detection circuit configured to detect a position of the cookware;
a display including a set of rows of lights, the set of rows of lights including:
a first row of lights representative of a first range of heat levels for the first portion; and
a second row of lights representative of a second range of heat levels for the second portion; and
a controller in communication with the detection circuit and the display, wherein the controller is configured to:
adjust power to the plurality of heater coils in response to detection of the position of the cookware; and
selectively energize one of the first row of lights and the second row of lights in response to detection of the position of the cookware.

2. The cooktop of claim 1, wherein the first range of heat levels has a first minimum heating capacity and a first maximum heating capacity, wherein the second range of heat levels has a second minimum heating capacity and a second maximum heating capacity, and wherein the second minimum heating capacity is equal to or greater than the first maximum heating capacity.

3. The cooktop of claim 2, wherein the first row of lights extends between a first end light corresponding to the first minimum heating capacity and a second end light corresponding to the first maximum heating capacity, and wherein the second row of lights extends between a third end light corresponding to the second minimum heating capacity and a fourth end light corresponding to the second maximum heating capacity.

4. The cooktop of claim 3, wherein the first row of lights is parallel to and noncolinear with the second row of lights.

5. The cooktop of claim 4, wherein the controller is configured to illuminate a target light of the set of rows of lights in a high illumination mode, the target light corresponding to the position of the cookware on either of the first portion or the second portion.

6. The cooktop of claim 5, wherein the controller determines a target heat level for the cookware based on the position of the cookware.

7. The cooktop of claim 6, wherein the controller is configured to activate only the target light at the high illumination mode of all lights in the set of rows of lights.

8. The cooktop of claim 6, wherein the controller is configured to:
determine a target row among the first row of lights and the second row of lights that includes the target light; and
operate only the target light in the high illumination mode of all lights in the target row.

9. The cooktop of claim 5, wherein the controller is configured to:
determine a target row among the first and second rows of lights that includes the target light; and
activate only lights in the target row that correspond to heating levels equal to and lower than the target heat level.

10. The cooktop of claim 1, wherein each of the first row of lights and the second row of lights is a one-dimensional array of lights, and wherein the controller activates at least a portion of one of the first row of lights and the second row of lights to indicate the position of the cookware and a target heat level for the cookware.

11. The cooktop of claim 1, wherein the first range of heat levels is different than the second range of heat levels.

12. A system for indicating a target heat level of and a position of cookware on an induction cooktop, comprising:
a first row of lights representative of a first range of heat levels for a first portion of a cooking area of said induction cooktop; and
a second row of lights representative of a second range of heat levels for a second portion of the cooking area of said induction cooktop adjacent to the first portion;
a controller in communication with the first and second rows of lights and configured to:
adjust power to heater coils of the cooking area based on the position of the cookware; and
selectively energize one of the first row of lights and the second row of lights in response to detection of the position of the cookware, wherein each of the first row of lights and the second row of lights is a one-dimensional array of lights, and wherein the controller activates at least a portion of one of the first row of lights and the second row of lights to indicate the position of the cookware and the target heat level.

13. The system of claim 12, wherein the first range of heat levels has a first minimum heating capacity and a first maximum heating capacity, wherein the second range of heat levels has a second minimum heating capacity and a second maximum heating capacity, and wherein the second minimum heating capacity is equal to or greater than the first maximum heating capacity.

14. The system of claim 13, wherein the first row of lights extends between a first end light corresponding to the first minimum heating capacity and a second end light corresponding to the first maximum heating capacity, and wherein the second row of lights extends between a third end light corresponding to the second minimum heating capacity and a fourth end light corresponding to the second maximum heating capacity.

15. The system of claim 14, wherein the first row of lights is parallel to and noncolinear with the second row of lights.

16. The system of claim 12, wherein the controller is configured to illuminate a target light in one of the first row of lights and the second row of lights in a high illumination mode, the target light corresponding to the position of the cookware on either of the first portion or the second portion.

17. The system of claim 16, wherein the controller is configured to activate only the target light at the high illumination mode of all lights in the set of rows of lights.

18. The system of claim 15, wherein the controller is configured to:
determine a target row among the first row of lights and the second row of lights that includes the target light; and
operate only the target light in the high illumination mode of all lights in the target row.

19. The system of claim 15, wherein the controller is configured to:
determine a target row among the first and second rows of lights that includes the target light; and
activate only lights in the target row that correspond to heating levels equal to and lower than the target heat level.

20. A cooktop, comprising:
a plurality of heater coils for heating cookware on at least one of a first portion and a second portion of a cooking area of said cooktop;
a detection circuit configured to detect a position of the cookware;
a display including a set of rows of lights, the set of rows of lights including:
a first row of lights representative of a first range of heat levels for the first portion; and
a second row of lights representative of a second range of heat levels for the second portion, wherein the first range of heat levels has a first minimum heating capacity and a first maximum heating capacity, wherein the second range of heat levels has a second minimum heating capacity and a second maximum heating capacity, and wherein the second minimum heating capacity is equal to or greater than the first maximum heating capacity; and
a controller in communication with the detection circuit and the display, wherein the controller is configured to:
adjust power to the plurality of heater coils in response to detection of the position of the cookware; and
selectively energize one of the first row of lights and the second row of lights in response to detection of the position of the cookware.
